(19) United States
(12) Patent Application Publication
(10) Pub. No.: US 2015/0319644 A1
(43) Pub. Date: Nov. 5, 2015

(54) A METHOD AND A SYSTEM FOR SHARING WIRELESS BROADBAND CONNECTION BETWEEN DEVICES

(71) Applicant: TELEFONICA, S.A., Madrid (ES)

(72) Inventors: Yan GRUNENBERGER, Madrid (ES); Konstantina PAPAGIANNAKI, Madrid (ES)

(73) Assignee: TELEFONICA, S.A., Madrid (ES)

(21) Appl. No.: 14/436,590

(22) PCT Filed: Oct. 18, 2013
(86) PCT No.: PCT/EP2013/071857

§ 371 Date: Apr. 17, 2015

(30) Foreign Application Priority Data
Oct. 19, 2012 (EP) 12382408.8

(51) Int. Cl. H04W 28/06; H04W 84/12; H04L 29/06; H04W 88/18; H04W 76/02

(52) U.S. Cl. CPC H04W 28/065; H04W 88/182; H04W 76/023; H04L 69/22; H04W 84/12

(57) ABSTRACT

The method comprising allowing a wireless broadband connection between at least one wireless device including a tethering function with at least one wired broadband device, and using said tethering function for sharing said wireless broadband connection through aggregating a bandwidth of said wired broadband device to said at least one wireless device, wherein a segmentation of application packets of information, at the layer of the application protocol enabling said connection, namely the application layer, is performed into sub packets that will be transmitted to said at least one wireless device, using a proxy including a set of application handler modules handling packets of information for said connection.

The system of the invention is adapted to implement the method of the invention.

### FIELD OF THE ART

The present invention generally relates to the field of network communications, and more particularly, to a method and a system for sharing wireless broadband connection between devices.

### PRIOR STATE OF THE ART

Sparsely populated rural areas are likely to have restricted wired broadband performance to households due to long distances to DSLAMs or cable head ends. In addition, due to their sparse population are by default not cost effective areas for the expansion of wired telecommunication infrastructure (especially to each home). At the same time such areas tend to be covered by 3G and soon 4G towers that could provide significant uplink, downlink performance (if within the cell coverage area).

FIG. 1 shows an example of the current situation of a household connectivity options.

An internet service provider delivers WAN (Wide Area Network) connectivity to a traditional wired connection using ADSL, SDSL, (Cable TODO check rates) or fiber optics through the use of a gateway that redistributes the connectivity through a WiFi LAN (Local Area Network) interface inside the home. In the home, different types of devices are present; device with a dual connectivity: WAN (through cellular 3G embedded modem) and LAN (WiFi, Bluetooth, Ethernet over USB) such as tablets or smartphones. Others devices are the one with a single connectivity with a LAN interface (WiFi, Ethernet) like the typical laptops and PCs.

A known (and already present on the market technique) called tethering enables mobile devices to share their wireless cellular connection to others devices through the mean of another interface (USB cable, bluetooth or WiFi connection); Each device hardware and software is considered capable of tethering and authorized by the wireless provider to do so. Using tethering, each device can share its WAN connectivity through the LAN connectivity. This invention intends to exploit this through aggregation.

There are some related patent applications trying to perform such operation. For instance US 20120077483 Enabling Interface Aggregation of Mobile Broadband Network Interfaces which discloses several two interfaces placed on a single device; typically these network interfaces have WiFi and a 3G capability.

Another patent application is WO 2012006595 Transparent Proxy Architecture for Multi-Path Data Connections describing aggregation with cooperation with the network. A middle box aggregates bandwidths that are put on different links depending on several criteria, e.g. bandwidth, congestion and/or latency. Again, the aggregation is limited to single devices and only managed inside the network.

Patent US 2008253282 System And Method For Transmitting A Data Flow Via Bundled Network Access Links As Well As An Auxiliary Transmitter And Receiver Device And Transmission And Receiving Methods Therefore. This patent discloses a system and a method for transferring a data flow via bundled network access links as well as to an auxiliary transmitter device and to an auxiliary receiver device and to a transmission and receiving method therefore. The referred patent uses a middle box, accessible from different paths for merging several contributions before sending the final content.

In the present invention, however, no bundling of any access link occurs.

Finally, patent application US 2011296006 “Cooperative bandwidth aggregation using multipath transport” propose a solution for performing several different ways of WAN tethering in combination with a multipath transport protocol. This proposed solution comes closer to the present invention, however, US 2011296006 solution is addressed to a protocol level working at the transport layer (i.e. below the normal application level) meaning that any implementation of said proposed solution needs a transport specific implementation (MPTCP) changing the structure of the servers and of an associated tunneling entity.

On contrary, the present invention works with the application layer being agnostic from the transport protocol or any other lower protocols in the communication stack. Furthermore, the present invention capabilities can dynamically be added to any device by known application deployment and discovery methods, e.g. over-the-air updates (plug-in effect).

Moreover, US 2011296006 focus on cellular aspects while the present invention exploits WWAN interface and local interface (i.e. USB, WiFi or any other).

The present invention, proposes the augmentation of a primary wired broadband connection with a number of mobile broadband connections (that are increasing in number within homes—smartphones, tablets, consumer electronics). So, it increases the use of bandwidth in sparsely populated areas, e.g. rural areas, and it better used the available bandwidth in a home area.

An aim of the invention is to be as retro-compatible or retro-fitting as possible with existing systems.

### SUMMARY OF THE INVENTION

Principles of the invention, in illustrative embodiments thereof, advantageously provide a method for sharing wireless broadband connection between devices. The method, as commonly in the field, comprising allowing a wireless broadband connection between at least one wireless device that includes a tethering function with at least one wired broadband device and using said tethering function for sharing said wireless broadband connection through aggregating a bandwidth of said wired broadband device to said at least one wireless device.

In the method, in a characteristic manner, a segmentation of application packets of information at the application protocol layer enabling said connection, namely the application layer, is performed into sub packets that will be transmitted to the at least one wireless device, using a proxy including a set of application handler modules handling packets of information for said connection.

By proxy it has to be understood any module, unit or box that can be located either at a gateway/router or in user equipment itself, and that allows said application packet of information segmentation.

The application handler module works under request. In an embodiment, loopholes in different protocols can be exploited by downloading a plurality of chunks of a single file in a video streaming protocol or even by downloading a part of the content from a content server by using headers having specific content-ranges. In this case, for packets comprising video streaming relying on an HTTP Live streaming, an initial video request is decoded and translated into multiple sub flows to gather a plurality of video chunks over the wireless devices participating in said connection.

In an embodiment, for packets comprising audio and/or video flows using a SIP protocol, the application handler preferably assigns audio flow and signaling to the wireless devices having a lower bandwidth and assigns video flow to the wireless devices having a higher bandwidth.

In yet another embodiment, for packets comprising HTTP acceleration, the application handler module performs a pre-parser and a pre-fetch step to a webpage according to a policy defined in said application handler module. Therefore, the sub packets may be sending over different communication channels.

The wired broadband device is for example an 802.11 gateway device and the wireless device is at least one of a mobile phone, a laptop, a computer, and/or a tablet computer, among other devices with computing capacities.

In another embodiment, the wireless device is attached or docked to the 802.11 gateway device and performs said wireless broadband connection sharing through said connecting interface by using a wired connectivity, for instance via a USB connection.

In another embodiment, the wireless broadband connection sharing of the wireless device is done by using a virtualization equipment, said virtualization equipment being connected to said 802.11 gateway device.

The wireless device and said wired broadband device are located within a home area so that said bandwidth aggregation takes place inside said home area.

In yet another embodiment, several of said wireless devices can be connected to the wired broadband device.

Further principles of the invention, in illustrative embodiments thereof, advantageously provide a system for sharing wireless broadband connection between devices. The system comprising a wireless device including a tethering function and being configured to allow a wireless broadband connection with at least one wired broadband device, said tethering function being used for sharing said wireless broadband connection through aggregating a bandwidth of said wired broadband device to said at least one wireless device. In a characteristic manner the system also includes means configured for performing a segmentation of application packets of information, at the layer of the application protocol enabling said connection, into sub packets that will be transmitted to the at least one wireless device, using a proxy. The proxy includes a set of application handler modules handling packets of information for said connection.

In the system each of said application handler module includes:
a parser unit that recognises the application packets of information coming from the proxy and segments said application packets of information, preferably, according to a criteria defined by the application handler module taking into account for instance the size of the packet, the type, etc.
scheduler unit that at least orients the application packets of information to any of the devices participating in the connection, and keeps track of the flow followed by said application packets of information; and
a sequencer unit that at least gathers the application packets of information coming from said wireless device participating in said connection and reconstructs said segmented application packets or coming from said scheduler unit.

The scheduler unit may also retransmit the flow in case a disconnection or interruption of the broadband connection takes place or any of the devices participating therein cancels the connection.

The scheduler receives data, either from the sequencer or directly from the wireless device/s participating in the connection, but everything starts on a request for said data, so that as the request is started in the application handler module, the sequencer already knows from which unit or device will receive the data.

In an embodiment, the wired broadband device is an 802.11 gateway device, having a bus with a plurality of data connections, and said wireless device is connected to said bus with said plurality of data connections.

The system of the invention is adapted to implement the method of the invention.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 is an illustration showing the typical household connectivity options.

FIG. 2 is an illustration of the procedure for performing the aggregation through a gateway, so aggregation is enabled through docking capabilities of the gateway.

FIG. 3 is an illustration of the procedure of performing the aggregation through WiFi, so enabling aggregation through WiFi virtualization.

FIG. 4 is an illustration of the procedure of performing the aggregation through WiFi, so enabling aggregation through regular WiFi and applications.

FIG. 5 is an illustration showing the multi-paths support problem with current Internet underlying infrastructure.

FIG. 6 is the proposed solution for the multi-paths problem according to an embodiment.

FIG. 7 details the middle box illustrated in FIG. 6 showing the different modules and/or elements to provide bandwidth aggregation. As said this different modules and/or elements are configured to work at the application layer.

FIG. 8 illustrates the different units that form part of an application handler module.

FIG. 9 is an illustration showing the HTTP Live stream protocol loophole used for multi-path aggregation, according to an embodiment.

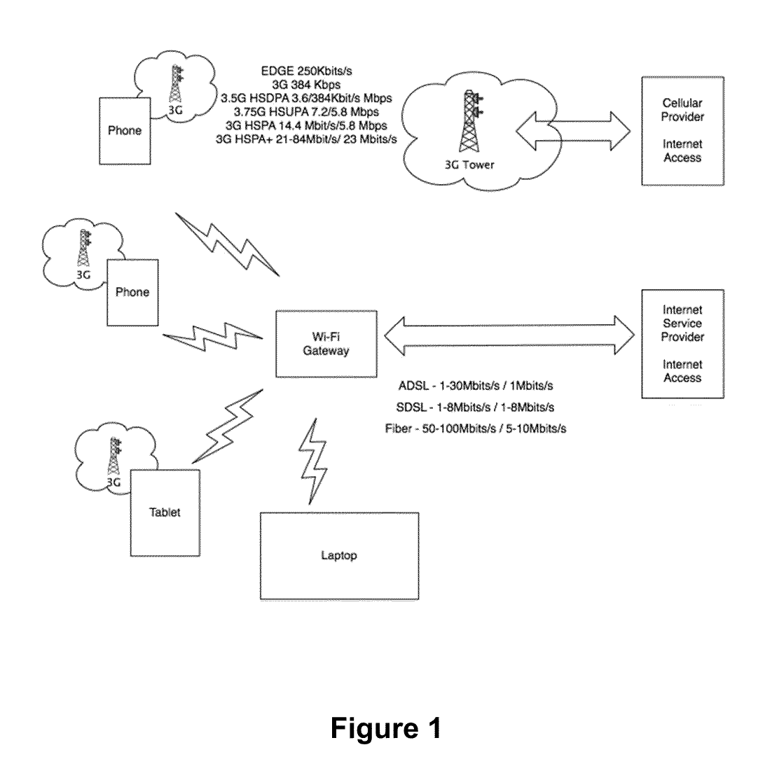

### DETAILED DESCRIPTION OF SEVERAL EMBODIMENTS

Enabling Aggregation:

The aggregation could be enabled through different techniques.

Aggregation through the gateway: This technique exploits the fact the centralized position of the gateway. The gateway is usually fitted with some USB connectors for media streaming, printer sharing, but this connection could be generalized to bus providing power and data connection. The invention proposes to use this bus connection as a docking facility for the device of the home, so that:
The devices get recharged through the power line of the power lines, a typical process that every smartphone user does every night.
The devices share their cellular connection with the gateway through the data lines, where lies the novelty.

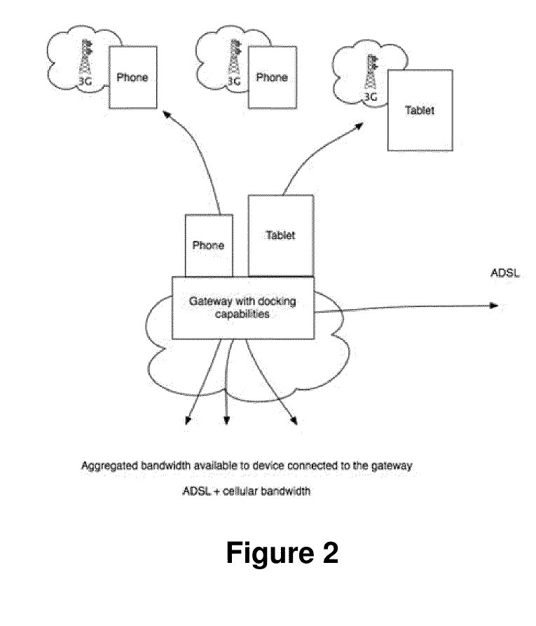

FIG. 2 shows an embodiment of the overall procedure. Multiple devices are connected and recharging, while sharing their internet connection through wired tethering via their USB connection.

Aggregation through WiFi: This technique involves relying on the WiFi as a common medium to aggregate the bandwidth. The invention distinguishes a case where it benefits from WiFi virtualization techniques, and the case it has to manage with regular WiFi.

Using WiFi Virtualization:

The invention reuses the same approach as the one presented with the ClubWiFi technology developed in TID, a “Method and single radio station for managing station throughputs from a wireless multiple access points backhaul” and “WIFI backhaul aggregation for all”.

In that case, the different access points are replaced by mobiles phones sharing their internet connection through tethering. A device equipped with WiFi virtualization could connect simultaneously to multiple mobile devices at the same time as well as the home WiFi network, resulting in enabling aggregation of the home backhaul bandwidth and the remaining 3G bandwidth given by each phone of the house.

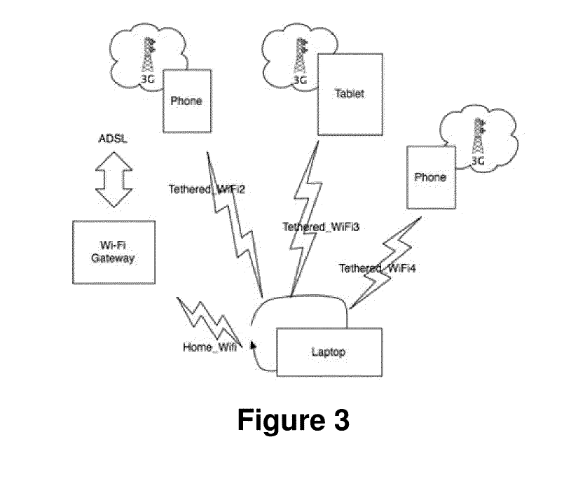

As presented on FIG. 3, a virtualization-enabled client can cycled through the different connections using a single WiFi card, enabling aggregation by switching from one network to another.

Using Standard WiFi:

In the case of standard WiFi, the invention will work in a degraded mode, as it will use the WiFi of the home network as a way to aggregate bandwidth. In that case, all devices (laptop, mobiles devices) are connected as simple clients of the WiFi network. Each mobile devices run a small application that:
listen incoming connection from the WiFi network
route all the traffic coming from this socket to the 3G network

Aggregation is then enabled at any client capable of running a program or a library that:
discover all the mobile devices sharing their connection through the home WiFi network
dispatch the traffic between the gateway and the different mobile devices sharing the connection on the WiFi network.

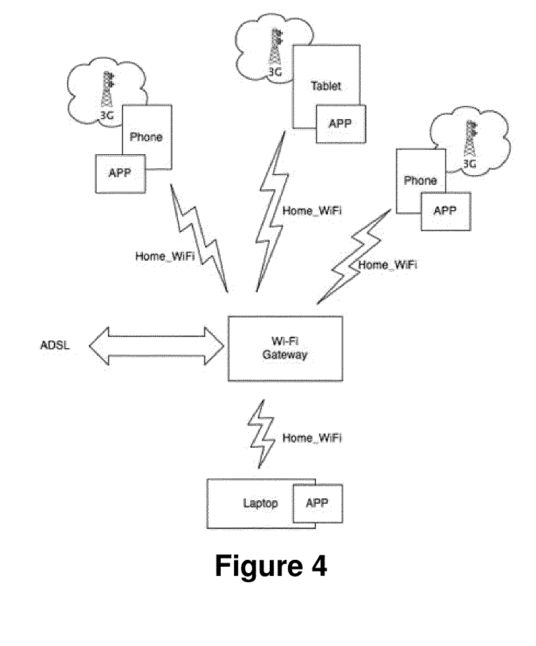

FIG. 4 shows in an embodiment this situation. A client device (laptop) is connected and running an application that will connect to all the mobile devices and will enable aggregation.

In that case the aggregation is done in a degraded way, as the same WiFi network bandwidth is shared between the multiple devices competing for the very same access. Nevertheless, with the increasing modulation of the WiFi (reaching 450 Mbps) the invention expects the available bandwidth to be larger than the offered bandwidth by each phone (3G speeds).

Performing Aggregation:

Previous section has presented the different techniques to enable aggregation. In this section, will be focus on how to perform this aggregation so that applications can benefit from it.

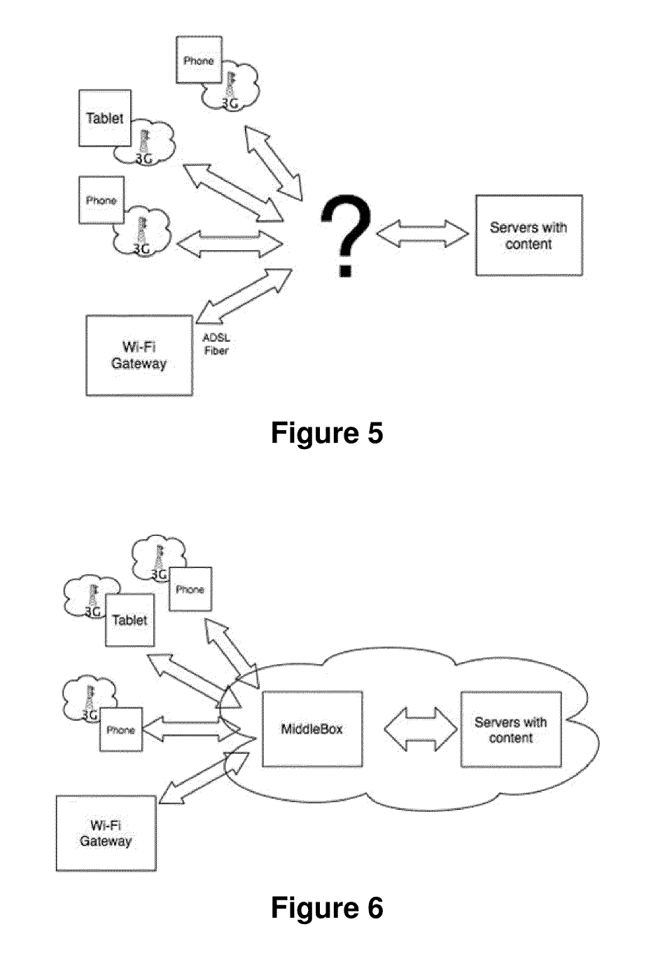

The problem is stated on FIG. 5. Most content server is relying on TCP/IP paradigms that do not support multi path schemes out of the box. Therefore, the invention try to address here the problem of managing the new multiple paths coming from the aggregation technology, with the reality of the current Internet content servers, by proposing two solutions.

With Network Cooperation:

In this solution it is assumed that the network will provide a cooperative support to the aggregation through multi path contributions. FIG. 6 shows in an embodiment the proposed solution where a middle box, accessible from the different paths is merging the different contributions before contacting the final content. A similar approach is taken from the patent US 2008253282, except there is no bundling of access links, but aggregation of connections through multiple devices that have a single access link each.

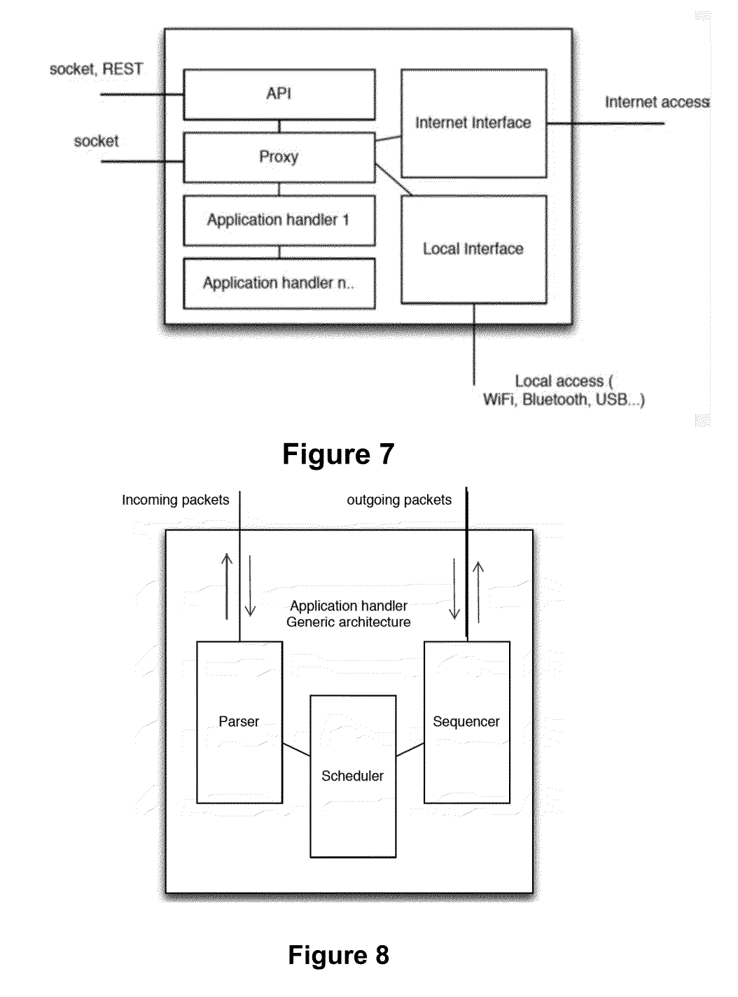

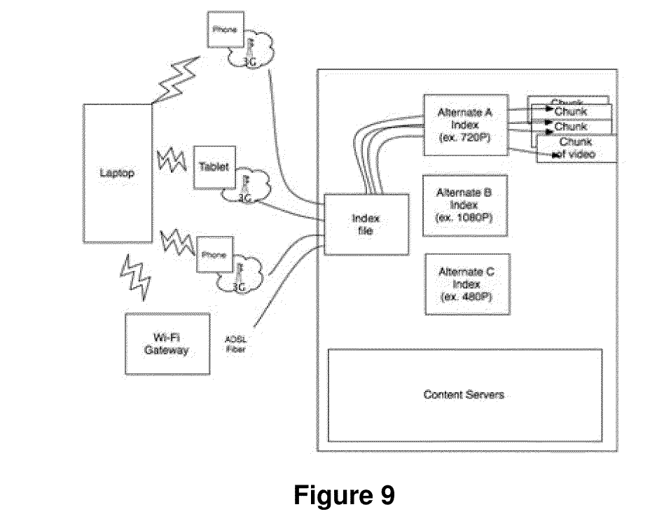

In reference now to FIG. 7 it is illustrated the main modules and elements for allowing performing the bandwidth aggregation. As said, a segmentation of packets or smart decomposition of application protocols into sub packets that will be dispatched among the various devices participating in the broadband connection is performed at the application layer. To that end, following capabilities are implemented:
a generic API (socket or REST as illustrated in FIG. 8) will be accessible and implemented by third party implementation. To that end, an API discoverability module is included in order the generic API being found by the device on the same network. The discoverability module will also include management function in order allowing permission of the APIs.
for wireless devices unable to use the tethering functions natively (i.e., not being able to implement the API), a proxy is used. This proxy is accessible at the UDP, TCP, or HTTP level, or any protocol implementable on the platform where the tethering function is hosted. On this proxy, a set of application handler modules are included that are responsible for transforming single flow (single packet), single link application flow into multiple flows (or sub packets). These handlers can dynamically be added to any device by known application deployment or deployable via over-the-air updates.

In reference to FIG. 8 are illustrated the different units that these handlers include in order to handle the packets of information.
a parser, recognizing the application packets coming to the proxy and performing a segmentation of the said application packets preferably according to a criteria defined by the application handler (for instance by taking into account size of the packet, type, etc. . . . ).
a scheduler, which is responsible for orienting packet to any of the device participating to the connection, and that will be keeping track of the flow going out through the said participating devices. This unit as an improvement may be also in charge of retransmitting the flow if a disconnection of said connection occurs or a device is leaving the scheme.
a sequencer that can gather the data coming from the scheduler or the data coming from de wireless devices participating in the connection and reconstruct the original application protocol. I.e., this unit is the responsible of selecting the channel by witch data will be communicated. Furthermore, the sequencer may also store the incoming or outgoing data.

The invention no needs for retro-fitting many changes in existing systems and/or solutions, for instance in the internet/network itself, being a simple solution. Three different exemplary embodiments are described based on known protocols.

Considering that the application handler is able to work at multiple levels:

The invention exploits loopholes in different protocols in use on the Internet to exploit the multi-path capabilities. Upon a request is made for said video streaming by an user of one of the wireless devices, said request will be decoded and translated into multiple sub flow in order to gather a plurality of video chunks over the wireless devices participating in the connection. For instance:
Video streaming: a popular video streaming protocol, HTTP Live streaming offer a playlist of chunks of the original file, with different alternate streams of different bitrates. Based on that knowledge, different path can download different chunk of the same file. FIG. 7 describes such an operation.
A more generic approach can be applied with large content hosted on HTTP 1.1 compliant servers. In that case, each path could download a part of the content by using the specific Content-Range: headers.

In an embodiment, the feasibility of such a scheme with the real cellular network in production use was explored. Up to 10 phones in 5 different locations were used. Table 1 illustrates the location.

TABLE 1
Different locations used for 3GOL active experiments
and comparison with the DSL and cellular capacity.

| | | | | DSL | Cellular | 3GOL/DSL |
|---|---|---|---|---|---|---|
| Location | Time | | Description | (d/u) | (d/u) | (d/u) |
| 1 | 1 | a.m | Densely | 3.44/0.30 | 4.37/1.64 | 2.27/6.46 |
| | | | populated | Mbps | Mbps | |
| | | | residential | | | |
| | | | area (city | | | |
| | | | center) | | | |
| 2 | 4 | p.m | Office area | 4.51/0.47 | 4.56/5.18 | 2.01/□12.02 |
| | | | rush hour | | Mbps | |
| 3 | 10 | p.m. | Residential | 6.72/0.84 | 1.92/1.53 | 1.28/□2.82 |
| | | | Area in | | Mbps | |
| | | | Tourist | | | |
| | | | hotspot | | | |
| 4 | 1 | a.m. | Sparsely | 2.84/0.45 | 4.67/3.89 | 2.64/9.64 |
| | | | populated | | Mbps | |
| | | | residential | | | |
| | | | (suburbs) | | | |
| 5 | 2 | p.m. | Popular | N/A | 5.31/2.64 | N/A |
| | | | shopping | | Mbps | |
| | | | center in | | | |
| | | | peak time | | | |

The results showed that downstream capacity can be augmented by up to 14 Mbps in the downlink, and 10 Mbps in the uplink. In 4 of 5 locations, these benefits were given through association with 2 different base stations. In the shopping mall, devices connecting to 6 different base stations were found, clearly demonstrating a denser 3G deployment, with load being balanced across the network. Measurements in Location 2 are also taken during peak hours (4 pm) but the cellular network seems to be much better provisioned, leading to a linear increase in downlink throughput up to 10 devices.

The behaviour on the uplink was significantly different. For 2 out of the 5 locations, it was observed a clear plateau in aggregation at 5 devices, equal to nearly 5 Mbps, which is the capacity for HSUPA (5.76 Mbps). For the shopping mall location, even 10 devices are unable to receive the theoretical maximum, possibly due to congestion. Interestingly, though, Location 3 does exceed 5 Mbps, and reaching 10 Mbps. For that particular location, all 10 devices are primarily using one base station. It is believed that for this particular experiment, while all phones were connected to one base station, they were connected to different sectors, thus going beyond the HSUPA capacity per sector. Such an assumption is plausible since Location 3 is a hub for tourists with a large density of cellular infrastructure.

In another embodiment, for instance for the case of audio and/or video flows using a SIP protocol, the wireless devices having lower bandwidth can be assigned with the audio and signaling flows, while the wireless devices having higher bandwidth can be assigned with the video flows.

Finally, in yet another embodiment, for the case of HTTP acceleration, a webpage may be pre-parsed and pre-fetched according to a policy defined in the application handler module.

It will be understood that the invention disclosed and defined herein extends to all alternative combinations of two or more of the individual features mentioned or evident from the text or drawings. All of these different combinations constitute various alternative aspects of the invention.

1. A method for sharing wireless broadband connection between devices, comprising:
allowing a wireless broadband connection between at least one wireless device including a tethering function with at least one wired broadband device; and
using said tethering function for sharing said wireless broadband connection through aggregating a bandwidth of said wired broadband device to said at least one wireless device, characterized in that the method comprises performing a segmentation of application packets of information, at the layer of the application protocol enabling said connection, namely the application layer, into sub packets that will be transmitted to said at least one wireless device, using a proxy including a set of application handler modules handling packets of information for said connection.

2. A method according to claim 1 wherein each of said application handler module comprises:
a parser unit recognizing the application packets of information coming to the proxy and segmenting said application packets of information;
a scheduler unit orienting the application sub packets of information to said devices participating in said connection and keeping track of the flow followed by said application packets of information;
a sequencer unit gathering the application packets of information coming from said wireless device participating in said connection and reconstructing said segmented application packets or coming from said scheduler unit.

3. A method according to claim 2, wherein said segmenting of the application packets of information is performed according to a criteria defined by the application handler module comprising at least size of the packet of information and/or type.

4. A method according to claim 2, wherein said scheduler unit further comprises retransmitting said flow if a disconnection or interruption of said wireless broadband connection takes place or any of said devices cancels the connection.

5. A method according to claim 2, wherein said sequencer unit further stores said gathered and reconstructed application packets.

6. A method according to claim 1, comprising:
for packets comprising video streaming relying on an HTTP Live streaming, decoding and translating a request for said video streaming into multiple sub flow to gather a plurality of video chunks over the wireless devices participating in said connection;
for packets comprising audio and/or video flows using a SIP protocol, assigning audio flow and signaling to the wireless devices having a lower bandwidth and video flow to the wireless devices having a higher bandwidth;
for packets comprising an HTTP acceleration, performing a pre-parser step and a pre-fetch step according to a policy defined in said application handler module.

7. A method according to claim 1, wherein said one wired broadband device is an 802.11 gateway device and said wireless device is at least one of a mobile phone, a laptop, a computer, and/or a tablet computer.

8. A method according to claim 7, wherein it comprises attaching or docking said wireless device to said 802.11 gateway device and performing said wireless broadband connection sharing through said connecting interface by using a wired connectivity.

9. A method according to claim 8, wherein said wired connectivity is made through a USB connection.

10. A method according to claim 1, comprising locating said wireless device and said one wired broadband device within a home area so that said bandwidth aggregating takes place inside said home area.

11. A method according to claim 10, comprising connecting several of said wireless devices to said one wired broadband device.

12. A system for sharing wireless broadband connection between devices, comprising a wireless device including a tethering function and being configured to allow a wireless broadband connection with at least one wired broadband device, said tethering function being used for sharing said wireless broadband connection through aggregating a bandwidth of said wired broadband device to said at least one wireless device, characterized in that comprises:
means configured for performing a segmentation of application packets of information, at the layer of the application protocol enabling said connection, into sub packets that will be transmitted to said at least one wireless device, using a proxy; and
said proxy including a set of application handler modules handling packets of information for said connection.

13. A system according to claim 12, wherein each of said application handler module comprises:
a parser unit that recognises the application packets of information coming to the proxy and segments said application packets of information;
scheduler unit that at least orients the application sub packets of information to said wireless device participating in said connection, and keeps track of the flow followed by said application packets of information; and
a sequencer unit that at least gathers the application packets of information coming from said wireless device participating in said connection and reconstructs said segmented application packets or coming from said scheduler unit.

14. A system according to claim 12, wherein said one wired broadband device is an 802.11 gateway device having a bus with a plurality of data connections, and said wireless device is connected to said bus with said plurality of data connections.
